(19) United States
(12) Patent Application Publication
(10) Pub. No.: US 2009/0008529 A1
(43) Pub. Date: Jan. 8, 2009

(54) Flexible Mold and Methods

(75) Inventors: Takaki Sugimoto, Tokyo (JP); Akira Yoda, Tokyo (JP)

Correspondence Address: 3M INNOVATIVE PROPERTIES COMPANY, PO BOX 33427, ST. PAUL, MN, 55133-3427, US

(73) Assignee: 3M INNOVATIVE PROPERTIES COMPANY, Saint Paul, MN (US)

(21) Appl. No.: 10/599,314

(22) PCT Filed: Mar. 24, 2005
(86) PCT No.: PCT/US2005/009678

§ 371 Date: Sep. 2, 2008

(30) Foreign Application Priority Data
Apr. 1, 2004 (JP) 2004-108999

(51) Int. Cl. B28B 7/06

(52) U.S. Cl. 249/127; 264/225

(57) ABSTRACT

Presently described are (e.g. flexible) molds, methods of making such molds, as well as methods of making microstructured articles. In particular, the present invention is directed to molds suitable for making ceramic microstructures on a substrate using a mold.

### BACKGROUND

Advancements in display technology, including the development of plasma display panels (PDPs) and plasma addressed liquid crystal (PALC) displays, have led to an interest in forming electrically-insulating ceramic barrier ribs on glass substrates. The ceramic barrier ribs separate cells in which an inert gas can be excited by an electric field applied between opposing electrodes. The gas discharge emits ultraviolet (UV) radiation within the cell. In the case of PDPs, the interior of the cell is coated with a phosphor that gives off red, green, or blue visible light when excited by UV radiation. The size of the cells determines the size of the picture elements (pixels) in the display. PDPs and PALC displays can be used, for example, as the displays for high definition televisions (HDTV) or other digital electronic display devices.

One way in which ceramic barrier ribs can be formed on glass substrates is by direct molding. This has involved laminating a planar rigid mold onto a substrate with a glass- or ceramic-forming composition disposed therebetween. The glass or ceramic-forming composition is then solidified and the mold is removed. Finally, the barrier ribs are fused or sintered by firing at a temperature of about 550° C. to about 1600° C. The glass- or ceramic-forming composition has micrometer-sized particles of glass frit dispersed in an organic binder. The use of an organic binder allows barrier ribs to be solidified in a green state so that firing fuses the glass particles in position on the substrate.

Although various methods and flexible molds suitable for making barrier ribs have been described, industry would find advantage in improvements.

### SUMMARY OF THE INVENTION

Presently described is a (e.g. flexible) mold suitable for replicating a microstructured pattern in the production of a microstructured article.

In one embodiment, the (e.g. flexible) mold comprises a support comprising a composite material of a polymeric material and a reinforcing material and a shape-imparting microstructured surface layer disposed on the support. The microstructured surface may comprise a recess pattern (e.g. groove pattern) or a protrusion pattern.

In another embodiment, a (e.g. flexible) mold having a coefficient of hygroscopic swelling of less than about 7 ppm per percent relative humidity (% RH) is described. The coefficient of hydroscopic swelling is preferably less than about 5 ppm per % RH, more preferably less than about 3 ppm, and more preferably less than about 1 ppm per % RH.

In other embodiments methods for producing a microstructured article are described comprising

providing any one of the (e.g. flexible) described herein;

disposing a curable material between a (e.g. glass panel) substrate and the shape-imparting microstructured surface layer of the mold;

curing the curable material; and

removing the mold.

In yet another embodiment, methods for producing a (e.g. flexible) mold are described. A preferred method comprises

providing a master mold having a surface protrusion pattern;

applying a curable resin composition to the surface protrusion pattern forming shape-imparting precursor layer;

providing a support layer on the shape-imparting layer wherein the support layer comprises a composite material of a polymeric material and a reinforcing material;

curing the curable resin composition of shape-imparting precursor layer; and

releasing the shape-imparting layer together with the support from the master mold.

### BRIEF DESCRIPTION OF THE DRAWINGS

FIG. 1 is a cross-sectional view schematically showing one exemplary plasma display panel (PDP).

FIG. 2 is perspective view showing an exemplary PDP back plate.

FIG. 3 is a perspective view showing an embodied flexible mold.

FIG. 4 is a cross-sectional view along the line IV-IV of the flexible mold shown in FIG. 3.

FIG. 5A-5C is a cross-sectional view sequentially showing an embodied production method of making flexible mold.

FIG. 6A-6C is a cross-sectional view sequentially showing another embodied production method of making a flexible mold.

FIG. 7A-7C is a cross-sectional view sequentially showing an embodied method of producing a microstructured body by using a flexible mold manufactured.

FIG. 8 is a plan view of a test composite film showing the positions of marking for measurement of dimensional change.

### DETAILED DESCRIPTION OF PREFERRED EMBODIMENTS

Presently described are (e.g. flexible) molds, methods of making such molds, as well as methods of making microstructured articles. In particular, the present invention is directed to molds suitable for making ceramic microstructures on a substrate using a mold. Plasma display panels (PDPs) can be formed using the molds and methods and provide a useful illustration of the methods. It is recognized that other devices and articles can be formed using these methods including, for example, lighting applications and electrophoresis plates with capillary channels. In particular, devices and articles that can utilize molded ceramic microstructures can be formed using the methods described herein. While the present invention is not so limited, an appreciation of various aspects of the invention will be gained through a discussion of molds and methods for the manufacture of barrier ribs for PDPs.

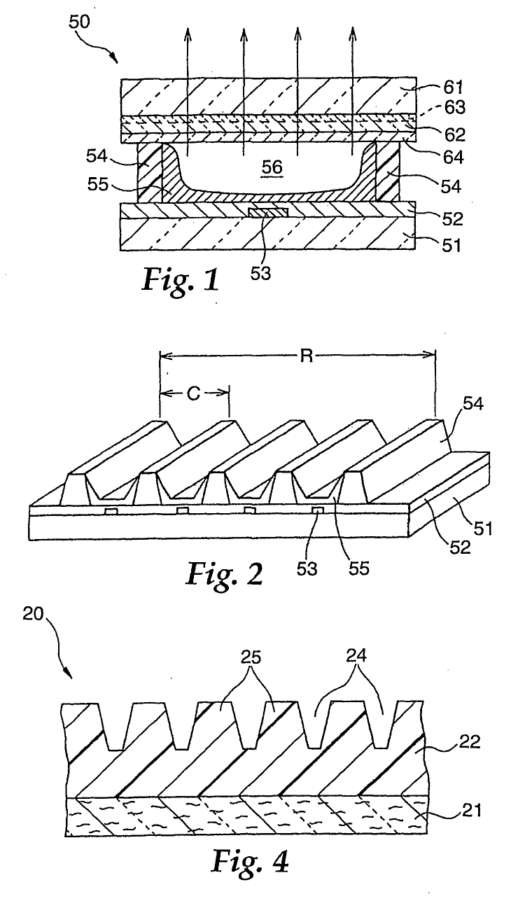

As schematically shown in FIG. 1, a PDP usually comprises a large number of fine discharge display cells. In PDP 50 shown, each discharge display cell 56 is surrounded and thereby defined by a pair of glass substrates opposing each other with a space therebetween, namely, a front glass substrate 61 and a back glass substrate 51, and microstructured ribs (also called barrier rib, separator wall or barrier wall) 54 disposed in a predetermined shape between these glass substrates. On the front glass substrate 61, a transparent display electrode 63 comprising a scanning electrode and a maintaining electrode, a transparent dielectric layer 62 and a transparent protective layer 64 are provided. On the back glass substrate 51, an address electrode 53 and a dielectric layer 52 are provided. The display electrode 63 comprising a scanning electrode and a maintaining electrode is arranged orthogonal to the address electrode 53 and respective electrodes are disposed at intervals in a fixed pattern. In each discharge display cell 56, a phosphor layer 55 is provided on the inner wall and a rare gas (for example, Ne—Xe gas) is enclosed, so that self-emission display can be made by plasma discharge between those electrodes.

In general, ribs 54 are formed by a ceramic microstructured body and as schematically shown in FIG. 2, usually provided in advance on the back glass substrate 51 together with address electrodes 53 and the dielectric layer 52 to constitute the back plate for PDP. The shape of ribs generally includes a straight pattern and a grid-like (matrix-like) pattern with grid-like patterns being preferred. The interval (cell pitch) C of ribs 54 varies depending on the screen size but is usually from about 150 to 400 μm.

Generally, the ribs satisfy two criteria, that is, “they are free from defects such as mixture of bubbles and deformation” and “they have high pitch accuracy”. As to pitch accuracy, the ribs are arranged at predetermined positions during molding with minimal positioning errors to address electrodes. The positioning error is no greater than one third of the average pitch. The positioning error is typically less than 25% of the average pitch, preferably less than 20% of the average pitch, more preferably less than 15%, and even more preferably less than 10% of the average pitch.

As the screen size becomes larger, pitch accuracy of the ribs becomes increasingly important. When the ribs 54 are taken into consideration as a whole, the total pitch R of the ribs 54 (distance between ribs 54 at both ends; though the drawing shows only five ribs, about 3,000 ribs exist generally) typically have a dimensional accuracy within 10 μm to 30 μm, though this may slightly vary depending on the substrate size and rib shape.

It is generally useful to form ribs by use of a flexible mold comprising a support and a shape-imparting layer having a microstructured (e.g. groove) pattern disposed on the support. In such method, the total pitch (distance between groove parts at both ends) of the mold has a dimensional precision similar to the ribs. When the mold is used, this dimensional precision is replicated in the microstructured article.

The PDP ribs shown can be produced by various methods. Preferably the PDP ribs are produced by manufacturing a (e.g. flexible) mold from a master mold. The master mold has a shape and dimension corresponding to the ribs to be formed.

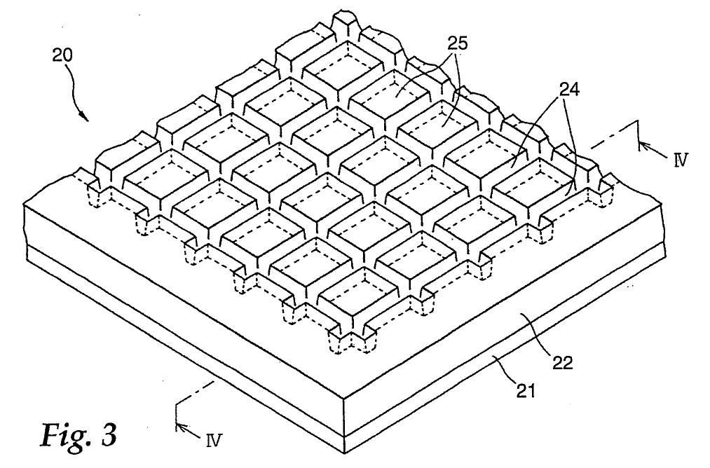

In one embodiment, the invention relates to a (e.g. flexible) mold, e.g. suitable for replicating a microstructured pattern in the production of a PDP ribs or other microstructured articles. One suitable pattern comprises a plurality of (e.g. groove) recesses substantially parallel with each other at regular intervals, such as shown in FIG. 2. Another suitable pattern is a grid-like pattern, such as shown in FIG. 3. The term “grid-like pattern” refers to any pattern having a structure approximating a grid. Examples of grid-like patterns include, but are not limited to, a meander pattern, a waffle (curb) pattern and a rhombic pattern. Even when the microstructured pattern is a complicated pattern such as a grid-like pattern, the flexible mold described herein provides a low peel force when removing the mold without breakage of the molded microstructure (e.g. barrier ribs).

With reference to FIGS. 3 and 4, in one embodiment, (e.g. flexible) mold 20 comprises:

(1) a support 21 comprising a composite material of a polymeric material and a reinforcing material, and

(2) a shape-imparting layer 22 having on the surface thereof a microstructured (e.g. groove) pattern 24 disposed on the support 21. The shape and a dimension of the microstructured pattern of the mold correspond (e.g. inverse) to the microstructured pattern of a microstructured article (not shown) to be produced. The depicted pattern 24 is a grid-like pattern 24 having a plurality (e.g. two sets) of groove recesses substantially in parallel intersection each other (e.g. spaced at regular intervals). The (e.g. rectangular) area 25, defined by the pattern 24 can define a discharge display cell (reference numeral 56 in FIG. 1) of a PDP panel. Alternatively, the shape-imparting layer, may have a protrusion pattern rather than a groove recess pattern.

The flexible mold comprises a support layer comprising a composite material of a polymeric material and a reinforcing material. The reinforcing material generally increases the (e.g. tear or tensile) strength of the composite material. The strength of the reinforced polymeric support layer can be expressed, for example, by rigidity against stretching, namely, tensile strength. The tensile strength of the reinforced polymeric film is usually at least about 5 kg/mm², preferably at least about 10 kg/mm². If the tensile strength of the reinforced polymeric film is less than 5 kg/mm², the handleability of the mold typically decreases and may result in breakage of the molded microstructures upon removal of the mold.

In some preferred embodiments, the mold exhibits improved dimensional stability in response to changes in humidity. The dimensional stability can be evaluated by determining the coefficient of hygroscopic swelling as determined according to the test method described in the examples. It is preferred that the (e.g. flexible) mold exhibits a coefficient of hydroscopic swelling of less than about 7 ppm per percent relative humidity (% RH). The coefficient of hydroscopic swelling is preferably less than about 5 ppm per % RH, more preferably less than about 3 ppm, and more preferably less than about 1 ppm per % RH.

For embodiments, wherein the mold will be used for molding a radiation curable material by means of curing through the mold, the mold materials (including the support) are chosen such that the mold has sufficient transparency to ionizing radiation such as ultraviolet ray (UV), electron beam (EB) and visible light.

A glass material can realize the dimensional stability against change in humidity, the transparency, for example, to UV and visible light and the high tensile strength, but typically reduces the flexibility. Furthermore, organic polymeric material may be used for the support but, despite its flexibility, this material has less dimensional stability against change in humidity.

Examples of polymeric materials suitable for the composite material include, but are not limited to, polyolefins such as polypropylene and cycloolefin, a polyvinyl chloride, a polystyrene, a polycarbonate, a polyethylene terephthalate (PET), a polybutylene terephthalate, a polyethylene naphthalate (PEN), a polyether sulfone, a polyphenylene sulfide and liquid crystal polymers. Polymeric materials commonly used as engineering plastic, superengineering plastic or the like can also be used. Among these, polyolefins such as polypropylene and cycloolefin are useful as the polymeric material.

Thermoplastic polymeric materials are surmised to be preferred as the polymeric material of the support. Although certain epoxy resins have been found to be unsuitable, other non-thermoplastic (e.g. thermosetting) polymeric materials are surmised to be suitable.

The (i.e. reinforced) composite support can be produced by blending a predetermined amount of reinforcing material with polymeric material. The blend is typically that formed into a pre-formed film. The (i.e. reinforced) composite support obtained can advantageously have good properties of both the polymeric material and the reinforcing material and this composite material can have dimensional stability against change in humidity, transparency to UV, visible light and the like, high tensile strength and flexibility against bending.

In the practice of the present invention, various reinforcing materials commonly used in the production of reinforced polymeric films can be used in various forms and in various amounts. Suitable examples of the reinforcing material include fibers or particles of an inorganic material, an organic material, a metal material, a metal oxide and the like. If desired, these materials may be used in the form of a mixture, a composite material or the like.

Examples of the fibers suitable as the reinforcing material include glass fibers such as E glass (i.e. aluminoborosilicate glass) fiber, carbon fibers, organic fibers, ceramic fibers such as alumina fiber and silica fiber, and metal fibers such as aluminum fiber, stainless steel fiber, copper fiber and brass fiber. If desired, the fibers may be used in the form of a knitted fabric, a non-woven fabric or the like. Furthermore, the fibers may be used in the form of a whisker, a continuous fiber, a long fiber, a short fiber or the like. The reinforcing fibers may be used in different diameters or aspect ratios, for example. The aspect ratio of the fibers used is preferably 3 or more.

As understood from the above, the shape of the reinforcing material can vary. For example, (e.g. glass) fiber typically has a diameter from about 5 to 30 μm. The (e.g. glass) fiber can be provided as continuous fiber, cut to a desired length, or a short fiber, having a length of about 5 mm or less.

The reinforcing material can be blended in various amounts with the polymeric material, but the amount blended is usually from about 20 to 70 vol-% based on the entire amount of the composite material. If the amount of the reinforcing material blended is less than 20 vol-%, the extent of reinforcement is typically insufficient, whereas if the amount exceeds 70 vol-%, a reduction in flexibility can result.

In the flexible mold of the present invention, the composite material for the support can comprise various combinations of the polymeric materials and reinforcing materials. Examples of the suitable combinations include for example

A) a combination of polypropylene and glass fiber,

B) a combination of cycloolefin and glass fiber,

C) a combination of polyphenylene sulfide and glass fiber, and

D) a combination of liquid crystal polymer and glass fiber.

The (i.e. reinforced) composite support may be used as a single layer film or, if desired, a multi-layer film or laminate having two or more layer wherein at least one of such layers comprising a composite support. The thickness of the composite support can vary depending of the relative strength of the composite material. Typically, the support have a thickness of at least about 50 μm, and no greater than about 1,000 μm. Preferably, the support has a thickness of about 100 μm and no greater than about 400 μm. If the thickness of the support is less than 50 μm, creasing or bending can occur. If the thickness of the support exceeds 1,000 μm, the flexibility of the film decreases and handleability is reduced.

The (i.e. reinforced) composite support is usually a sheet-like material obtained by calendering or coating the starting blend of polymeric material and reinforcing material. The composite support can be produced in sheet form or wound into a roll. Alternatively, various (i.e. reinforced) composite supports are commercially available. If desired, the support may be subjected to surface treatment to enhance, for example, the adhesive strength of the shape-imparting layer to the reinforced polymeric film. The surface treatment is appropriately a primer treatment. The primer treatment may be applied to the surface to receive the shape-imparting layer. One suitable primer composition is commercially available from 3M Company under the trade designation “K-500”. The primer treatment can be carried out in accordance with the conventional methods.

The ultraviolet curable resin composition may have various compositions but preferably comprises acrylic monomer and/or oligomer as the main component. The cured resin originated in this ultraviolet curable composition preferably has a glass transition point of about 0° C. or less.

Examples of the acrylic monomer suitable for the formation of the shape-imparting layer include, but are not limited to, urethane acrylate, polyether acrylate, polyester acrylate, acrylamide, acrylonitrile, acrylic acid and acrylic acid ester. Examples of the acrylic oligomer suitable for the formation of the shape-imparting layer include, but are not limited to, urethane acrylate oligomer, polyether acrylate oligomer, polyester acrylate oligomer and epoxy acrylate oligomer. In particular, the urethane acrylate or an oligomer thereof can provide a flexible and tough cured resin layer after the curing and among acrylates in general, this acrylate or an oligomer thereof can be cured at a very high speed. Furthermore, when such an acrylic monomer or oligomer is used, the shape-imparting layer can be optically transparent. Accordingly, the flexible mold having this shape-imparting layer is also advantageous in that a photocurable molding material can be used for the production of a PDP rib or other microstructured body.

These acrylic monomers and oligomers may be used individually or in combination of two or more thereof according to the desired constitution of the mold or other factors. The present inventors have found that when the acrylic monomer and/or oligomer is a mixture of urethane acrylate oligomer and monofunctional and/or bifunctional acryl monomer, particularly preferred results can be obtained. In this mixture, the mixing ratio of urethane acrylate oligomer and acryl monomer can be varied over a wide range, but the urethane acrylate oligomer is preferably used in an amount of about 20 to 80 wt % based on the total amount of oligomer and monomer. The urethane acrylate oligomer and the acryl monomer can be mixed at a ratio in such a wide range and therefore, the viscosity of the ultraviolet curable composition for the formation of the shape-imparting layer can be set to a value over a wide range suitable for the, as a result, the obtained mold can be favored with improvements, for example, the working at the production of the mold is facilitated and the layer thickness can be made uniform.

The ultraviolet curable composition typically comprises a photopolymerization initiator and other additives. Examples of the photopolymerization initiator include 2-hydroxy-2-methyl-1-phenylpropan-1-one. The photopolymerization initiator can be used in various amounts in the ultraviolet curable composition, but is preferably used in an amount of usually from about 0.1 to 10 wt % based on the entire amount of the acrylic monomer and/or oligomer. If the amount of the photopolymerization initiator is less than 0.1 wt %, the curing reaction proceeds at an extremely low rate or satisfactory curing is disadvantageously not obtained, whereas if the amount of the photopolymerization initiator exceeds 10 wt %, unreacted photopolymerization initiator remains even after the completion of curing step and this causes problems such as yellowing or deterioration of resin or shrinkage of resin due to volatilization. Examples of another useful additives include an antistatic agent.

In the formation of the shape-imparting layer, the ultraviolet curable composition can be used in various viscosities (Brookfield viscosity, so-called “B” viscosity), but usually, the viscosity is preferably from about 10 to 35,000 cps, more preferably from about 50 to 10,000 cps. If the viscosity of the ultraviolet curable composition is out of this range, problems may arise at the formation of the shape-imparting layer, such as difficult film formation or insufficient progress of curing.

The thickness of the shape-imparting layer is designed to be large correspondingly to the rib height, and thus can vary. The thickness of shape-imparting layer and thus barrier rib height is usually from at least about 5 μm and no greater than 1,000 μm. Preferably the thickness is at least about 10 μm and no greater than 800 μm. More preferably, the thickness is at least about 50 μm and no greater than 700 μm.

The (e.g.) microstructured pattern of the shape-imparting layer can vary. The depth, pitch and width of the groove pattern can vary depending on the desired PDP rib pattern (straight pattern or grid-like pattern). For grid-like PDP ribs, such as shown in FIGS. 3 and 4, the depth (corresponding to the rib height) of the groove pattern is usually at least about 100 μm and no greater than 500 μm. Preferably the depth is at least about 150 μm and no greater than about 300 μm. The pitch of the groove pattern, which may be different between the longitudinal direction and the cross direction, is usually at least about 100 μm and no greater than 600 μm. Further, the pitch is preferably at least about 200 μm and no greater than 400 μm. The width of the groove pattern, which may be different between the top face and the bottom face, is usually at least about 10 μm and no greater than 100 μm and preferably at least about 50 μm and no greater than 80 μm.

The production method of the flexible mold having the composite support can be produced with known methods. One preferred process comprises:

preparing a master mold (e.g. having on the surface thereof a protrusion pattern with a shape and a dimension corresponding to the microstructured pattern of the final objective microstructured body),

applying a curable resin composition (e.g. to a predetermined thickness on the pattern-forming surface of the master mold) to form a shape-imparting precursor layer,

laminating the composite support (i.e. of a polymeric material and a reinforcing material) on the shape-imparting precursor layer (i.e. to form a laminated body containing the master mold, the pre-shape-imparting layer and the support),

curing the curable resin composition of the shape-imparting precursor layer, and

releasing the (i.e. cured) shape-imparting layer, together with the support from the master mold to produce a flexible mold comprising a composite support and a shape-imparting layer. The “shape-imparting precursor layer” is a precursor of the shape-imparting layer, that can be converted into a shape-imparting layer by hardening (e.g. curing).

The method of the present invention can be advantageously practiced in various embodiments. For example, according to one preferred embodiment, a master mold having on the surface thereof a protrusion pattern with a shape and a dimension corresponding to the microstructured pattern of the microstructured body can be used as a master mold of the flexible mold. In the case where the microstructured body is a PDP rib, a pattern of fine protrusions with a shape and a dimension corresponding to ribs is imparted on the surface of the master mold. The master mold can be produced by forming a pattern of fine protrusions corresponding to ribs on a flat metal plate such as brass plate, by electrical, mechanical and/or physical working such as end mill, electric discharge machining and ultrasonic grinding. The master mold can alternatively be made of glass, ceramic or gypsum.

According to another preferred embodiment, the flexible mold is not produced directly from the master mold. In this case, more specifically, a master mold having the corresponding inverse pattern microstructured surface (e.g. groove pattern) as the microstructured article is prepared. For example, a master mold having a pattern of fine grooves corresponding to ribs can be produced on flat metal plate such as brass plate, by electrical, mechanical and/or physical working such as end mill, electric discharge machining and ultrasonic grinding.

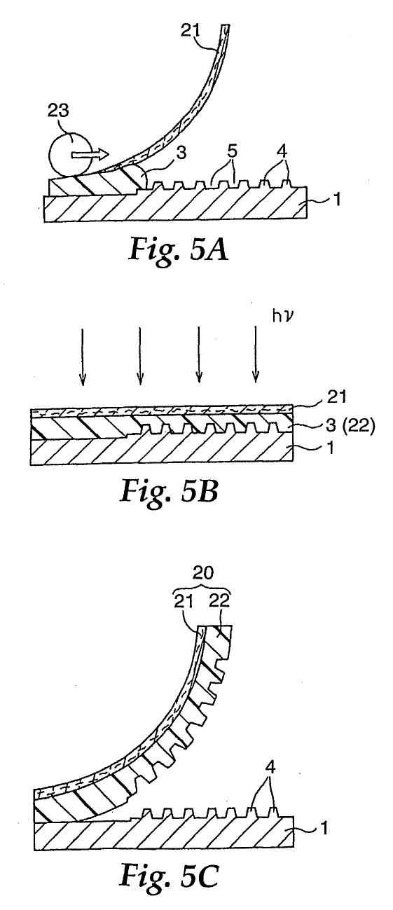

With reference to FIG. 5(A), a master mold 1 with a shape and a dimension corresponding to a PDP rib is first produced. The master mold 1 can be produced by machining a stainless steel plate. The master mold 1 has protrusions 4 with the same pattern and shape as ribs on a back plate for PDP and accordingly, the cavity (recessed part) 5 defined by adjacent protrusion 4 works out to a discharge display cell of PDP. The upper end of the protrusion 4 may be tapered so as to prevent entrapping of bubbles. In combination with this master mold 1, a support (hereinafter called a “support film”) 21 comprising a transparent polymeric film and a lamination roller 23 are prepared. The lamination roller 23 is used for pressing the support film 21 to the master mold 1 and comprises a rubber roll. If desired, other well-known or commonly employed laminating devices may be used in place of the lamination roller. The support film 21 is a transparent reinforced polymeric film as described above.

Then, an ultraviolet curable molding material 3 in a predetermined amount is coated on the end face of the master mold 1 by a well-known or commonly employed coating device (not shown) such as knife coater and bar coater. The ultraviolet curable molding material is used for forming the shape-imparting layer of the obtained flexible mold. Here, when a material having flexibility against bending and rigidity against stretching or compression is used as the support film 21, even if the ultraviolet curable molding material 3 is shrunk, the molding material is tightly contacted with the support 21 and therefore, a dimensional fluctuation of 10 ppm or more does not occur unless the support film itself is deformed.

Before the lamination treatment, the support film is preferably subjected to aging in the production environment of the mold so as to remove the dimensional change due to humidity. If this aging treatment is not performed, the obtained molds may have dimensional positioning errors (i.e. misalignment of microstructures) of an unacceptable level (for example, 300 ppm).

Subsequently, the lamination roller 23 is slid in the arrow direction on the master mold 1. As a result of this lamination treatment, the molding material 3 is uniformly distributed in a predetermined thickness and the gap between protrusions 4 is also filled with the molding material 3. Furthermore, the molding material 3 is pressed and spread by the support film 21 and therefore, good bubble venting can be attained as compared with conventionally and commonly employed coating methods. The molding material 3 in this state is a pre-shape-imparting layer referred to in the present invention.

After the completion of lamination treatment, as shown in FIG. 5(B), in the state of the support film 21 being laminated on the master mold 1, ultraviolet ray (hν) is irradiated in the arrow direction on the pre-shape-imparting layer 3 through the support film 21. Here, when the support film 21 is uniformly formed of a transparent material without containing a light-scattering element such as air bubble, the light irradiated can evenly reach the pre-shape-imparting layer 3 while scarcely undergoing attenuation. As a result, the molding material of the pre-shape-imparting layer 3 is efficiently cured to form a uniform shape-imparting layer 22 adhering to the support film 21. In this way, a flexible mold 20 where the support film 21 and the shape-imparting layer 22 are integrally joined is obtained. In this step, for example, ultraviolet ray at a wavelength of 350 to 450 nm can be used and this is advantageous in that a light source that generates high heat, such as high-pressure mercury lamp (e.g., fusion lamp), need not be used. Furthermore, by using ultraviolet curing, the support film or shape-imparting layer is free from thermal deformation and therefore, a high-level pitch control can be advantageously attained.

Thereafter, as shown in FIG. 5(C), the flexible mold 20 is separated from the master mold 1 while keeping its integrity.

Irrespective of the dimension or size, the flexible mold of the present invention can be relatively easily produced as long as a proper well-known or commonly employed laminating or coating device is used. Therefore, according to the present invention, unlike conventional production methods using vacuum equipment such as vacuum press-molding machine, a large-size flexible mold can be easily and simply produced with no limitations.

The flexible mold is useful for the production of various microstructured bodies. For example, the flexible mold is useful for the formation of ribs of PDP having a straight or grid-like rib pattern. When this flexible mold is used, a large-screen PDP having a rib structure that causes less leakage of ultraviolet ray from the discharge display cell to the outside, can be simply and easily produced by using a lamination roller in place of vacuum equipment and/or complicated process.

Furthermore, the flexible mold is useful for producing a structure where a plurality of ribs are disposed nearly in parallel while crossing each other at regular intervals, namely, a grid-like PDP rib. This flexible mold is a mold for the production of a large-size rib pattern having a complicated shape, nevertheless, the operation of disengaging the flexible mold from the master mold can be easily performed without causing problems such as deformation or breakage of the mold.

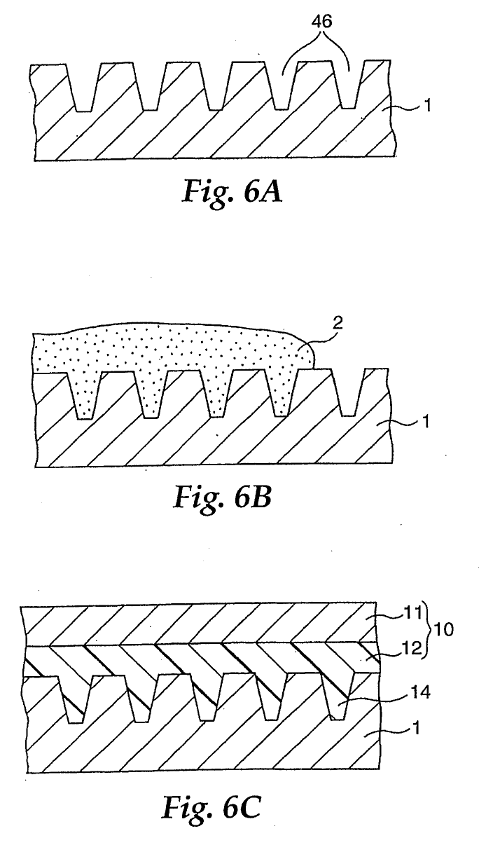

Alternatively, the flexible mold, can be prepared from a “transfer mold” as schematically shown in FIG. 6(C) and described in PCT patent application serial no. US04/43471. As shown in the Figure, the transfer mold 10 comprises:

(1) a base 11 comprising a hard material having a high modulus, and

(2) a transfer pattern layer 12 having on the surface thereof a protrusion pattern 14 with a shape and a dimension corresponding to a microstructured pattern (in the Figure, a fine PDP rib pattern) of a microstructured body, which is supported by the base 11.

FIG. 6 shows one preferred production method of a mold for transfer.

A master mold 1 as shown in FIG. 6(A) is first prepared. The master mold 1 comprises, for example, a stainless steel flat plate and has a groove pattern 46 with a shape and a dimension corresponding to the microstructured pattern of a microstructured body.

Then, as shown in FIG. 6(B), a two-liquid type room temperature curable silicone rubber 2 used as a precursor of the transfer pattern is applied to a predetermined thickness on the surface of the master mold 1 prepared. In the Figure, a method of coating a room curable silicone rubber 2 on the surface of the master mold 1 and sequentially filling the groove pattern 46 is employed, but other methods may be used. Subsequently, as shown in FIG. 6(C), a base 11 of the mold for transfer is laminated on the master mold 1 to form a laminated body comprising the master mold 1, the precursor of the transfer pattern layer, and the base 11. Finally, although not shown, the obtained mold for transfer is released from the master mold. The flexible mold described herein can be used to manufacture a microstructured article such as barrier ribs on an electrode patterned substrate according to known methods. This can be accomplished by providing the flexible mold (i.e. having the composite support), disposing a curable material (e.g. ceramic paste) between a substrate (e.g. glass panel) and the shape-imparting layer of the flexible mold to fill the protrusion-forming material in the groove pattern of the flexible mold, curing the curable material, and removing the mold. A production apparatus shown in FIGS. 1 to 3 of Japanese Unexamined Patent Publication (Kokai) No. 2001-191345 can be advantageously used.

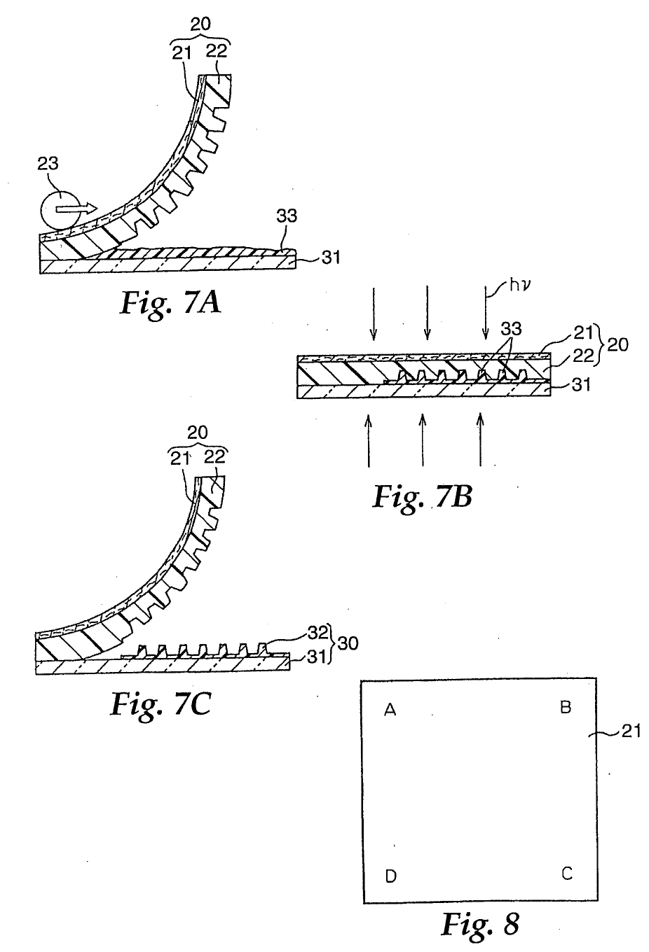

Although not shown, a glass flat plate having provided on the top face thereof striped electrodes in a predetermined pattern is first prepared and set on a table. Then, as shown in FIG. 7(A), a flexible mold 20 having on the surface thereof a groove pattern is disposed at a predetermined position on the glass flat plate 31 and alignment of the glass flat plate 31 and the mold 20 is performed. Here, the glass flat panel 31 has address electrodes and a dielectric layer as shown in FIG. 2, but these are omitted for the simplification of description. The mold 20 is transparent and therefore, alignment with electrodes on the glass flat panel 31 can be easily performed. More specifically, this alignment can be performed with an eye or by using a sensor such as CCD camera. At this time, if desired, the groove parts of the mold can be agreed with the distance between adjacent electrodes on the glass flat plate 31 by adjusting the temperature and humidity, because the mold 20 and the glass flat plate 31 each usually undergoes expansion or shrinkage according to the change of temperature and humidity and the degree thereof differs from each other. After the alignment of the glass flat plate 31 and the mold 20 is completed, these are controlled to maintain the temperature and humidity at that time. This control is effective particularly in producing a large-area PDP substrate.

Subsequently, a lamination roller 23 is placed on one end part of the mold 20. The lamination roller 23 is preferably a rubber roller. At this time, the one end part of the mold 20 is preferably fixed on the glass flat plate 31, so that the glass flat plate 31 and the mold 20 after the completion of alignment above can be prevented from misalignment.

Then, the other free end of the mold 20 is lifted by a holder (not shown) and moved toward the upper portion of the lamination roller 23 to expose the glass flat plate 31. At this time, care is taken not to apply a tension to the mold 20 so as to prevent occurrence of creasing on the mold 20 and maintain the alignment between the mold 20 and the glass flat plate 31. However, as long as the alignment is maintained, other means may be used. In this production method, the molding shape 20 has elasticity and therefore, even when hoisted as shown in the Figure, the mold 20 can be returned to exactly the original aligned state at the subsequent lamination.

Thereafter, a rib precursor 33 in a predetermined amount necessary for the formation of ribs is supplied on the glass flat plate 31. The rib precursor can be supplied, for example, by using a paste hopper with a nozzle.

The rib precursor as used herein means an arbitrary molding material capable of forming the final objective rib shaped body and as long as the rib shaped body can be formed, the rib precursor is not particularly limited. The rib precursor may be heat-curable or photocurable. In particular, photocurable rib precursor are preferably employed in combination with a transparent flexible mold in order to cure the rib precursor through the mold. As described above, the flexible mold is almost free of air bubble or defects such as deformation and can prevent non-uniform light scattering or the like. Accordingly, the molding material is uniformly cured and constant ribs with good quality can be formed.

One example of the composition suitable for the rib precursor is a composition comprising (1) a ceramic component, such as aluminum oxide, (2) a glass component for filling the gap between ceramic components and imparting denseness to ribs, such as lead glass and phosphoric acid glass, and (3) a binder component for housing, holding and binding the ceramic components with each other and a curing agent or a polymerization initiator therefor. The binder component is preferably cured by light irradiation but not by heating or elevation of temperature. In the case of curing by light irradiation, deformation of the glass flat plate need not be feared. The rib precursor usually has a viscosity of about 20,000 cps or less, preferably about 5,000 cps or less.

Subsequently, the rib precursor is cured, preferably by exposure to ultraviolet light is irradiated on the rib precursor through the flat glass plate and the mold to cure the rib precursor. In this way, a shaped body of the rib precursor is obtained, that is, ribs themselves are obtained.

Finally, while leaving the obtained ribs adhering to the flat glass plate, the mold is separated and removed.

### EXAMPLES

The present invention is described below by referring to Examples.

### Example 1

### Method of Making Flexible Mold

In this Example, a flexible mold having on the surface thereof a grid-like groove pattern as shown in FIGS. 3 and 4 was manufactured for producing a PDP back plate having ribs (partitions) in a grid-like pattern.

For the manufacture of the flexible mold, cells each having a dimension of 700 μm (length)×200 μm (width)×20 mm (thickness) were regularly machined on one surface of a brass plate of 210 mm (length)×300 mm (width)×20 mm (thickness) to form cells longitudinally in a total number of 180 at a longitudinal cycle of 800 μm and transversely in a total number of 840 at a transverse cycle of 270 μm. The cells are used for defining discharge display cells on the objective back plate for PDP. A master mold having on the surface thereof a grid-like protrusion pattern was obtained. In this master mold, the protrusion pattern consisted of longitudinal protrusion parts and transverse protrusion parts and these protrusion parts each had a cross section of isosceles trapezoid and were disposed nearly in parallel while crossing each other at regular intervals.

By using this master mold, a flexible mold was manufactured according to the method described above by referring to FIG. 5.

First, for use in the formation of a shape-imparting layer of the mold, two ultraviolet curable resin compositions each having the following composition were prepared.

### High-Viscosity Ultraviolet Curable Resin Composition (A):

| | |
|---|---|
| Aliphatic urethane acrylate oligomer (“Photomer 6010”, | 80 wt % |
| trade name, produced by Henkel Corporation) | |
| 1,6-Hexanediol diacrylate (produced by Shin-Nakamura | 20 wt % |
| Chemical Co., Ltd.) | |
| 2-Hydroxy-2-methyl-1-phenyl-propan-1-one | 1 wt % |
| (photopolymerization initiator, “Dalocure 1173”, trade name, | |
| produced by Ciba Specialty Chemicals) | |

### Low-Viscosity Ultraviolet Curable Resin Composition (B):

| | |
|---|---|
| Aliphatic urethane acrylate oligomer (“Photomer 6010”, | 40 wt % |
| trade name, produced by Henkel Corporation) | |
| 1,6-Hexanediol diacrylate (produced by Shin-Nakamura | 60 wt % |
| Chemical Co., Ltd.) | |
| 2-Hydroxy-2-methyl-1-phenyl-propan-1-one | 1 wt % |
| (photopolymerization initiator, “Dalocure 1173”, trade name, | |
| produced by Ciba Specialty Chemicals) | |

The viscosity of each resin composition was measured by a Brookfield (B) viscometer, as a result, the viscosity of Resin Composition (A) was 8,500 cps and the viscosity of Resin Composition (13) was 110 cps (shaft #5, 20 rpm, 22° C.).

Furthermore, for use as a support of the mold, a reinforced polypropylene (PP) film of 300 mm (length)×300 mm (width)×0.2 mm (thickness) was provided. This reinforced PP film was a product reinforced with a continuous fiber of E glass (aluminoborosilicate glass) in which E glass has a diameter of about 10 μm and is contained in a volume percentage of about 50%, commercially available from Toyobo Co., Ltd. under the product name “Quick Form”.

On one surface of this reinforced PP film, Ultraviolet Curable Resin Composition (A) prepared was coated to a thickness of about 100 μm. Separately, Ultraviolet Curable Resin Composition (B) was coated on the protrusion pattern surface of the master mold produced in the previous step. Thereafter, the reinforced PP film and the master mold were laminated by superposing respective resin coatings one on another. The longitudinal direction of the reinforced PP film was laid in parallel with the longitudinal protrusion part of the master mold and the total thickness of ultraviolet curable resin compositions sandwiched by the reinforced PP film and the master mold was set to about 250 μm. The reinforced PP film was pressed by using a lamination roller, as a result, the ultraviolet curable resin composition was completely filled in recessed parts of the master mold and entrapping of air bubbles was not observed.

In this state, ultraviolet ray having a wavelength of 300 to 400 nm (peak wavelength: 352 nm) was irradiated for 30 seconds on the ultraviolet curable resin composition layer through the reinforced PP film by using a fluorescent lamp manufactured by Mitsubishi Electric Osram Ltd. The dosage of ultraviolet ray was from 200 to 300 mJ/cm². Both ultraviolet curable resin compositions were cured and a shape-imparting layer was obtained. Subsequently, the reinforced PP film was separated together with the shape-imparting layer from the master mold, as a result, a flexible mold having on the surface thereof a grid-like groove pattern with a shape and a dimension corresponding to the grid-like protrusion pattern of the master mold was obtained. The thickness of this flexible mold was about 450 μm.

### Example 2

### Manufacture of PDP Back Plate from Flexible Mold

In this example, by using the flexible mold produced in Example 1, a PDP back plate (microstructured body referred to in the present invention) was manufactured according to the method described above by referring to FIG. 7.

The flexible mold was aligned with and disposed on a glass substrate for PDP. Subsequently, a photosensitive ceramic paste was filled between the mold and the glass substrate to a thickness of 110 μm. The ceramic paste used here had the following composition.

| | |
|---|---|
| Photocurable oligomer: bisphenol A diglycidyl methacrylate | 21.0 g |
| acid adduct (produced by Kyoeisha Chemical Co., Ltd.) | |
| Photocurable monomer: triethylene glycol dimethacrylate | 9.0 g |
| (produced by Wako Pure Chemical Industries, Ltd.) | |
| Diluent: 1,3-butanediol (produced by Wako Pure Chemical | 30.0 g |
| Industries, Ltd.) | |
| Photopolymerization initiator: bis(2,4,6-trimethylbenzoyl)- | 0.3 g |
| phenylphosphine oxide (“Irgacure 819”, trade name, | |
| produced by Ciba Specialty Chemicals) | |
| Surfactant: POCA (phosphate polyoxyalkyl polyol, produced | 1.5 g |
| by 3M) | |
| Sulfonic acid-base surfactant (“Neopelex No. 25”, trade | 1.5 g |
| name, produced by Kao Corporation) | |
| Inorganic particle: mixed powder of lead glass and ceramic | 270.0 g |
| (“RFW-030, trade name, produced by Asahi Glass Co., Ltd.) | |

The viscosity of this ceramic paste was measured by a Brookfield (3) viscometer and found to be 7,300 cps (shaft #5, 20 rpm, 22° C.).

After coating this ceramic paste on the entire surface of the glass substrate, the mold was laminated to cover the surface of the glass substrate. The mold was pressed by using a rubber-made lamination roller having a diameter of 200 mm and a weight of 30 kg, the ceramic paste was completely filled in the recessed parts of the mold.

In this state, blue light having a wavelength of 400 to 500 nm (peak wavelength: 450 nm) was irradiated for 30 seconds from both surfaces of the mold and the glass substrate by using a fluorescent lamp manufactured by Philips Co. The dosage of ultraviolet ray was from 200 to 300 mJ/cm². The ceramic paste was cured and ribs were formed. Subsequently, the glass substrate was separated together with ribs formed thereon, from the mold, as a result, a glass substrate with grid-like ribs was obtained. In the obtained glass substrate, the shape and dimension of the ribs corresponded with the shape and dimension of groove part of the master mold used for the manufacture of the flexible mold. Finally, the glass substrate was baked at 550° C. over 1 hour, thereby removing organic components in the paste. A PDP back plate with grid-like ribs comprising only the glass component was obtained. The ribs were inspected for defects by an optical microscope but defects such as chipping of rib were not observed.

### Test Example 1

### Measurement of Dimensional Change of Composite Film

In this Example, the dimensional change of the composite film used as the support in the flexible mold of the present invention was measured by changing the relative humidity at 22° C. from 85% RH to 55% RH, and the measurement was performed according to the following procedure.

### 1. Preparation of Test Composite Film

The reinforced PP film (300 mm (length)×300 mm (width)×0.2 mm (thickness)) used as the support of the flexible mold in Example 1 was used as the test composite film.

### 2. Marking for Measurement of Dimension

As shown in FIG. 8, marking for measurement of dimension was affixed to four corners (four points of A, B, C and D, distance between points: 250 mm) of the test composite film 21.

### 3. Constant-Temperature and Constant-Humidity Storage

The test composite film of the step 2 was placed in a constant-temperature and constant-humidity oven at 22° C./55% RH and stored over 1 week.

### 4. Measurement of XY Coordinate

The test composite film of the step 3 was taken out from the oven and the XY coordinate at four points (four points of A, B, C and D) was immediately measured on a measuring apparatus. At the measurement, the conditions were 22° C./55% RH. The measurement results are shown in “Data 1” of Table 1 below.

### 5. Constant-Temperature and Constant-Humidity Storage

The test composite film of the step 2 was placed in a constant-temperature and constant-humidity oven at 22° C./85% RH and stored over 1 week.

### 6. Measurement of XY Coordinate

The test composite film of the step 5 was taken out from the oven and the XY coordinate at four points (four points of A, B, C and D) was immediately measured on a measuring apparatus. At the measurement, the conditions were 22° C./55% RH. The measurement results are shown in “Data 2” of Table 1 below.

### 7. Measurement of Dimensional Change

The measurement results (dimension between respective points) obtained in the step 4 and the step 6 were compared, as a result, dimensional changes shown in “Difference” of Table 1 below were confirmed.

Also, the coefficient of hydroscopic swelling between respective points was calculated. The results are shown in Table 1 below.

TABLE 1

| Test Example 1 | A-B | B-C | C-D | D-A |
|---|---|---|---|---|
| Data 1 (mm) | 249.821 | 250.729 | 255.695 | 255.010 |
| Data 2 (mm) | 249.822 | 250.729 | 255.696 | 255.010 |
| Difference (mm) | 0.001 | 0.000 | 0.000 | 0.000 |
| Coefficient of Hydroscopic | 0.2 | 0.0 | 0.1 | 0.0 |
| Swelling (ppm/% RH) | | | | |

As understood from the results in Table 1, the composite film tested in this example exhibited no significant dimensional change against the change of 30% RH of relative humidity.

### Test Example 2

### Measurement of Dimensional Change of Flexible Mold

In this example, the dimensional change of the flexible mold of the present invention was measured by changing the relative humidity at 22° C. from 85% RH to 55% RH, and the measurement was performed according to the following procedure.

### 1. Preparation of Flexible Mold

The flexible mold described in Example 1 was produced under the same production conditions. A flexible mold having a thickness of 450 μm, where a shape-imparting layer comprising a cured product (Tg: −40° C.) originated in urethane acrylate and acryl monomer was laminated on a support comprising a reinforced PP film, was obtained.

### 2. Marking for Measurement of Dimension

In the same manner as in Test Example 1, marking for measurement of dimension was affixed to four corners (four points of A, B, C and D, distance between points: 250 mm) of the test mold.

### 3. Constant-Temperature and Constant-Humidity Storage

The test mold of the step 2 was placed in a constant-temperature and constant-humidity oven at 22° C./55% RH and stored over 1 week.

### 4. Measurement of XY Coordinate

The test mold of the step 3 was taken out from the oven and the XY coordinate at four points (four points of A, B, C and D) was immediately measured on a measuring apparatus. At the measurement, the conditions were 22° C./55% RH. The measurement results are shown in “Data 3” of Table 2 below.

### 5. Constant-Temperature and Constant-Humidity Storage

The test mold of the step 2 was placed in a constant-temperature and constant-humidity oven at 22° C./85% RH and stored over 1 week.

### 6. Measurement of XY Coordinate

The test mold of the step 5 was taken out from the oven and the XY coordinate at four points (four points of A, B, C and D) was immediately measured on a measuring apparatus. At the measurement, the conditions were 22° C./55% RH. The measurement results are shown in “Data 4” of Table 1 below.

### 7. Measurement of Dimensional Change

The measurement results (dimension between respective points) obtained in the step 4 and the step 6 were compared, as a result, dimensional changes shown in “Difference” of Table 2 below were confirmed.

Also, the coefficient of hydroscopic swelling between respective points was calculated. The results are shown in Table 2 below.

TABLE 2

| Test Example 2 | A-B | B-C | C-D | D-A |
|---|---|---|---|---|
| Data 3 (mm) | 227.613 | 146.803 | 227.596 | 147.122 |
| Data 4 (mm) | 227.618 | 146.804 | 227.601 | 147.124 |
| Difference (mm) | 0.005 | 0.002 | 0.005 | 0.002 |
| Coefficient of Hydroscopic | 0.7 | 0.4 | 0.8 | 0.4 |
| Swelling (ppm/% RH) | | | | |

As understood from the results in Table 2, the mold tested in this example exhibited no significant dimensional change against the change of 30% RH of relative humidity.

### Example 3

The procedure in Test Example 1 was repeated but in this example, for the purpose of comparison, a composite film of epoxy glass, commercially available from Arisawa Mfg. Co., Ltd. was used in place of PP as the test composite film (reinforced polymeric film) and the size of the test composite film was changed to 300 mm (length)×300 mm (width)×0.25 mm (thickness).

The dimensional change of the composite film was measured according to the method described in Test Example 1. The results are shown in Table 3 below. In the Table, “Data 5” shows the results when stored in a constant-temperature and constant-humidity oven at 22° C./55% RH over 1 week, and “Data 6” shows the results when stored in a constant-temperature and constant-humidity oven at 22° C./85% RH over 1 week.

TABLE 3

| Comparative Test Example 1 | A-B | B-C | C-D | D-A |
|---|---|---|---|---|
| Data 5 (mm) | 250.462 | 178.018 | 262.515 | 165.271 |
| Data 6 (mm) | 250.523 | 178.063 | 262.570 | 165.310 |
| Difference (mm) | 0.061 | 0.044 | 0.055 | 0.039 |
| Coefficient of Hydroscopic | 8.1 | 8.3 | 7.0 | 7.8 |
| Swelling (ppm/% RH) | | | | |

As understood from the results of Table 3, the composite film tested in this example exhibited a hydroscopic swelling coefficient of about 8 ppm/% RH and underwent a significant dimensional change against the change of 30% RH of relative humidity.

### Example 4

The procedure in Test Example 2 was repeated but in this example, for the purpose of comparison, PP was replaced by epoxy resin in the reinforced polymeric film used as the support of the flexible mold and the size of the reinforced polymeric film was changed to 300 mm (length)×300 mm (width)×0.25 mm (thickness).

The dimensional change of the flexible mold was measured according to the method described in Test Example 2. The results are shown in Table 4 below. In the Table, “Data 7” shows the results when stored in a constant-temperature and constant-humidity oven at 22° C./55% RH over 1 week, and “Data 8” shows the results when stored in a constant-temperature and constant-humidity oven at 22° C./85% RH over 1 week.

TABLE 4

| Comparative Test Example 2 | A-B | B-C | C-D | D-A |
|---|---|---|---|---|
| Data 7 (mm) | 228.426 | 145.800 | 228.437 | 147.459 |
| Data 8 (mm) | 228.478 | 145.838 | 228.489 | 147.496 |
| Difference (mm) | 0.051 | 0.039 | 0.052 | 0.037 |
| Coefficient of Hydroscopic | 7.5 | 8.8 | 7.6 | 8.3 |
| Swelling (ppm/% RH) | | | | |

As understood from the results of Table 4, the flexible mold tested in this example exhibited a hydroscopic swelling coefficient of about 8 ppm/% RH and underwent a significant dimensional change against the change of 30% RH of relative humidity.

### Example 5

The procedure in Test Example 2 was repeated but in this example, for the purpose of comparison, a 188 μm-thick polyethylene terephthalate (PET) film was used as the support in place of the reinforced PP in the production of the flexible mold. The size of the PET film was 300 mm (length)×300 mm (width)×0.2 mm (thickness).

The dimensional change of the flexible mold was measured according to the method described in Test Example 2, as a result, this flexible mold exhibited a hydroscopic swelling coefficient of about 8 ppm/% RH and revealed to undergo a significant dimensional change against the change of 30% RH of relative humidity. The PET film used as the support also exhibited a hydroscopic swelling coefficient of about 8 ppm/% RH.

1. A mold comprising:
a support comprising a composite material of a polymeric material and 20 to 70 percent volume based on the composite of a reinforcing material blended with the polymeric material, and a shape-imparting surface layer disposed on the support.

2. The mold of claim 1 wherein the mold is flexible.

3. The mold of claim 1 wherein the shape-imparting surface layer is microstructured.

4. The mold of claim 3, wherein the microstructured surface comprises a groove pattern.

5. The mold of claim 3, wherein the microstructured surface comprises a protrusion pattern.

6. The mold of claim 3, wherein said reinforcing material comprises an inorganic material, an organic material, a metal material, a metal oxide or a mixture thereof.

7. The mold of claim 6, wherein said reinforcing material is a fiber.

8. The mold of claim 1, wherein said polymeric material is selected from the group consisting essentially of a polyolefin, a polyvinyl chloride, a polystyrene, a polycarbonate, a polyethylene terephthalate, a polybutylene terephthalate, a polyether sulfone, a polyphenylene sulfide and a liquid crystal polymer.

9. The mold of claim 8, wherein said polyolefin is a polypropylene or a cycloolefin.

10. The mold of claim 1, wherein said composite material comprises polypropylene and glass fiber.

11. The mold of claim 1, wherein said shape-imparting layer comprises a cured resin composition.

12. The mold of claim 11, wherein said cured resin composition is photocured.

13. The mold of claim 3, wherein the microstructured surface is a protrusion pattern corresponding to barrier ribs for a back plate of a plasma display panel.

14. A mold comprised of a polymeric material having a coefficient of hydroscopic swelling of less than 7 ppm per percent relative humidity.

15. The mold of claim 14 wherein the mold comprises a shape-imparting microstructured surface layer suitable for making barrier ribs.

16. The mold of claim 15, wherein the coefficient of hydroscopic swelling is less than 5 ppm per percent relative humidity.

17. The mold of claim 15, wherein the coefficient of hydroscopic swelling is less than 3 ppm per percent relative humidity.

18. The mold of claim 15, wherein the coefficient of hydroscopic swelling is less than 1 ppm per percent relative humidity.

19. A method of making a microstructured article comprising
providing the mold of claim 1;
disposing a curable material between a substrate and the shape-imparting microstructured surface layer of the mold;
curing the curable material; and
removing the mold.

20. A method for producing a flexible mold comprising:
providing a master mold having on a surface protrusion pattern;
applying a curable resin composition to the surface protrusion patter of the master mold to form a shape-imparting layer precursor;
providing a support layer on the shape-imparting layer wherein the support layer comprises a composite material of a polymeric material and 20 to 70 percent volume based on the composite of a reinforcing material blended with the polymeric material;
curing the curable resin; and
releasing the shape-imparting layer together with the support from the master mold.

21-22. (canceled)
